(19) United States
(12) Patent Application Publication
(10) Pub. No.: US 2013/0268203 A1
(43) Pub. Date: Oct. 10, 2013

(54) System and method for disease diagnosis through iterative discovery of symptoms using matrix based correlation engine

(71) Applicant: Vincent Thekkethala Pyloth, Bangalore (IN)

(72) Inventor: Vincent Thekkethala Pyloth, Bangalore (IN)

(21) Appl. No.: 13/480,488

(22) Filed: May 25, 2012

(30) Foreign Application Priority Data
Apr. 9, 2012 (IN) 1421/CHE/2012

(51) Int. Cl. G06F 19/00

(52) U.S. Cl. 702/19

(57) ABSTRACT

A system and method for disease diagnosis through iterative discovery of symptoms using matrix based correlation engine. The Dialog Manager uses the correlation engine to drive the dialogue with the user and presents optimum number of right questions based on which the system correlates and identifies probable disease (s) and the symptom (s) that has the maximum potential to narrow down the search, so as to reach a particular conclusion on disease type. The system computes the most probable disease based on the scores associated with various symptoms. The correlation engine is optimized by computing the probability of diseases using boost factor based on user profile, the total time lapsed from the onset of diseases etc. to enhance the accuracy of the disease identification. Based on the conclusions, Dialog Manager requests the Decision Support Engine for further suggestions and handles the subsequent interaction between the user and Decision Support Engine.

### PRIORITY CLAIM

This application the benefit under 35 U.S.C. §119 (b) of an application entitled “System and method for disease diagnosis through iterative discovery of symptoms using matrix based correlation engine” filed with Indian Patent Office Chennai on Apr. 9, 2012 and assigned an application No. 1421/CHE/2012, the entirety of which is expressly incorporated herein by reference.

### 1. FIELD OF THE INVENTION

The invention relates to a system and method for disease diagnosis through iterative discovery of symptoms using matrix based correlation engine. More particularly, the present invention relates to a system that drives the dialogue to ask optimum number of right questions for quick identification of most probable disease.

### 2. BACKGROUND OF THE INVENTION

Diagnosis of an accurate disease is a complex activity as there are numerous diseases and their associated symptoms that make the correlation between disease and symptom difficult, for accurate identification of disease. Most of the doctors today specialize in specific areas such as gynecology, cardiology etc. and view the symptoms and diseases through their specialization area, missing the diseases that fall outside their core area. The human based identification becomes even more complex when symptoms corresponding to multiple diseases are found in the same patient, each subset being treated by specialist doctor resulting in false identification as each doctor will assess disease from his/her own view point without any coordination or correlation between the associated symptoms from another disease. Symptoms of a disease (s) in a patient depends upon various factors such as body constitution, sex, age, presence of other diseases or the stage in the lifecycle of the disease manifestation. It is actually the correlation of several symptoms that gives the probability of a diseases than a binary yes/no answer to a fixed set of few symptoms. This correlation can be established based on various facts such as history, age, gender, primary disorders, life style etc.

The software based identification of the probable disease (s) based on a set of key symptoms is one of the most popular approaches for disease identification available today, but this approach does not help the end user when a given symptom (s) can be mapped to more than one disease. Also, the user often finds it tough to identify the accurate disease from the long list of probable diseases. It is highly laborious and time consuming process to go through all the probable diseases and hundreds of associated symptoms to identify the accurate disease.

US Patent no US2003045782A1 discloses a computerized medical diagnostic method that repetitively asks questions over time to the user to get a initial set of symptoms that contributes to the weight to at least one disease, determining one or more synergistic weights based on the symptom established over time to declare a total score for each applicable disease and determining the total score for a particular disease that reaches a threshold so as to declare a diagnosis but the invention focuses on the time based diagnosis, and it involves scripting (programming) of all the symptom and disease objects and does not clearly discuss about the identification of all associated diseases corresponding to the symptoms that drives the dialogue in order to accurately diagnose disease (s) and does not provide any algorithm that can implement automatic correlation purely based on mapping between symptoms and disease with no elaborate programming of the decision tree.

US Publication no 20080091631A1 discloses a computer software based disease diagnostic system that provides medical diagnosis or recommendation to the user based on the symptoms and medical history entered by the user, but the invention is also based on Implementation based on coding of diagnostic decision trees for every disease with custom branching based on each of the symptoms and does not clearly discuss about the method of identification of associated diseases based on the entered symptoms and driving a dialog with the end user based on automated intelligent correlation of symptoms and diseases.

Another important limitation of the software based current implementations is that the patient is aware of only the most important, highly visible or painful symptoms and is often ignorant or unaware of presence of the other related symptoms. User only realizes the presence of such symptoms when asked specifically by the doctor. Therefore, an important piece of information required for disease identification is missed out.

All the above factors complicate the process of disease identification either by a doctor or through an existing software implementation leading to inaccurate identification of disease (s) and wrong treatments along with increased cost of treatment and wastage of time. This becomes even more complicated in case of telemedicine systems where doctor is remotely located and there is a need for software assisted identification of disease (s) at least at the initial levels before routing to the right specialist.

For the foregoing reasons, there is a need for a disease diagnostic system that maps a given symptom to one or more diseases and also to correlate the associated symptoms for the mapped disease (s) in order to accurately identify the disease(s). Also needed is a method that allows the correlation to be handled in real time with minimal computing power, purely based on symptom to disease mapping and also without any explicit coding specific to all the diseases or symptoms. Such an approach will allow the implementation of the diagnostic system without large amount of computing power per user and can open up the possibility of ubiquitous implementation across multiple devices and technologies.

### 3. SUMMARY OF THE INVENTION

The present invention overcomes problems in the prior art and provides a software based iterative disease diagnostic system and method that uses a dialog based approach to receive confirmed initial symptoms from the user and a correlation engine to analyse the input received from the Dialog Manager. The system calculates the probability of diseases by mapping each symptom with probable disease and in case the probability of any disease is less than a predetermined threshold value, the correlation engine presents probable symptoms as choices to the user based on the probable disease to identify the most probable disease (s).

In most preferred embodiment, a system for disease diagnosis through iterative discovery of symptoms is disclosed. The system comprises a Dialog Manager to receive confirmed initial symptoms from the user. The Dialog Manager also allows subsequent interactions through a dialog for disease identification. The embodiment also includes a correlation engine configured to analyse the input received from the Dialog Manager and to calculate the probability of disease by mapping each symptom with probable diseases stored in the database and in case the probability of any disease is less than a predetermined threshold value, the system presents to the user a list of probable symptom related to probable disease to identify the most probable disease. The probable symptoms further comprise subset from the topmost symptoms in a ranked list of symptoms of probable diseases; this subset of probable symptoms is presented to the user via Dialog Manager for further confirmation. The ranked list comprises disease symptoms arranged in descending order of scores of all the symptoms of probable diseases. While calculating the scores of each symptom, the symptoms corresponding to disease with higher probabilities as compared to other symptoms are assigned more weightage to identify the topmost symptom that needs confirmation whereby presenting disease symptoms based on most likelihood of the disease. While presenting the probable symptoms to the user via Dialog Manager, the symptoms for which the user has already confirmed as either present or absent are not presented second time. The probable symptom choices are presented to the user via Dialog Manager for further confirmation from the user either for a fixed number of times or until the probability of any of the diseases is greater than a predetermined threshold value or based on other decisions both programmatic and user driven. The correlation engine is implemented solely based on the symptom disease mapping and can be optimized further by using boost factor to the probability calculations based on user's gender, age, demography, health profile, health history of past diseases, habits, stage of disease, primary/secondary diseases, hereditary issues and the total time lapsed from the onset of diseases to enhance the accuracy of the disease identification. The implementation is similar to the symptom disease correlation as done by a doctor and the various optimizations replicate the bias in disease identification similar to the bias considered by the doctors based on patient's health history of past diseases or demographics. The value of boost factor is increased in case the probability of the occurrence of disease is more whereas the value of boost factor is decreased in case the probability of the occurrence of disease is less. The correlation engine is also optimized by mapping the names of the symptoms to an internal symptom representation for inputs and using the preferred name set based on customization data corresponding to that user, for asking for confirmations whereby making the system easily usable by non-doctors. In one embodiment, the diseases are categorized based on the time from the onset of the disease with varying symptoms for correlating symptoms to a particular disease. The system also maintains the session information corresponding to the Dialog Manager and the Correlation Engine in order to optimize the queries and to ensure that no symptoms are verified the second time, once symptoms have been confirmed positive or negative by the user and also to handle all the correlation optimizations.

The system automatically drives the dialogue to ask optimum number of right questions from the user for quick identification of the most probable disease whereby mimicking the dialog between doctor and patient during the disease diagnosis process.

The system also includes a decision support engine to suggest further course of action upon detecting the most probable disease. The course of action suggested by the decision support engine further comprise logical next steps for confirmation and cure of the identified disease wherein the steps comprises any of the following such as suggesting a further diagnostic tests to confirm the identified disease, routing user to a specific hospital, routing user to a specific department in a hospital, suggesting a specialist doctor within a hospital, suggesting a specialist doctor close to patient's geographical location, scheduling a lab test, suggesting and ordering the required medicines online, blocking the calendar for consultation with the doctor, suggesting immediate help if the disease detected is critical or life threatening, direct interaction with the doctor using any communication mode like text or video chat etc. This optimizes the time spent by doctors by performing most of the basic disease detection process by the user upfront through self-service or through assistance by non-doctors before the specialist doctor starts attending the patient for further discussions.

All the three sub systems i.e. Dialogue manager, Correlation engine and Decision support engine can be distributed individually or in combination in different deployment environments as per specific requirements. The system may be implemented on a 2-way communication technology that allows 2-way communication with the end user. In one embodiment, the system may be implemented as a web based application. In another embodiment, the system may be implemented as a thick client standalone application. In one more embodiment, the system may be implemented as a hybrid combination between web based application and thick client standalone application in any of the technology platforms like PC/Laptop, Tablet, Mobile, TV, Gaming Console or any other technology platform that allows 2-way communication with the end user. The database (map between symptom and disease) accessed by the correlation engine is updated with newer diseases and new symptoms on an ongoing basis. The system can detect more than one disease from all the symptoms present, with associated relative probabilities, to help in relative comparison between diseases. The system supports multiple modes of user interaction for disease detection from the symptoms, said modes comprise at least one of text based/SMS mode, voice based, chat based, and web based.

In another embodiment, the invention provides a method for disease diagnosis through iterative discovery of symptoms, said method comprising the steps of pre-computing the symptom-disease weightage to reduce computation load and processing time during the initial setup, displaying a user interface for receiving confirmed initial disease symptoms from the user, computing the probability of diseases by establishing correlation of symptoms with disease type to identify the probable disease. In case the probability of any disease is greater than a predetermined threshold value, suggesting further course of action based upon the identification of the probable disease whereby successfully identifying the disease based on the symptoms selected by the user. In case the probability of any disease is less than a predetermined threshold value, the method further comprises the steps of calculating symptom scores for each probable symptom based on the probable disease, preparing list of probable symptoms by selecting subset from the topmost symptoms in the ranked list of symptoms for each of the probable diseases, wherein the ranked list further comprises probable symptoms for probable disease arranged in descending order of their score whereby symptoms having more significance for a disease are scored higher as compared to other symptoms to find out most probable disease, presenting list of probable symptoms as choices for probability calculations to the user, suggesting further course of action to the user upon identification of the most probable disease. While presenting probable symptom to the user, the confirmed initial symptoms are removed for confirmation of the specific disease whereby symptoms for which the user has already confirmed as either present or absent are not presented second time. While calculating the score of each symptom, the symptoms corresponding to disease with higher probabilities as compared to other symptoms are assigned more score. There is clear separation between the user specific data on symptoms present and probabilities of diseases and boost of probabilities based on biases etc. which are different for different users and the disease-symptom mapping which is same for every user that allows optimization of system resource usage in technical implementation.

The method drives the dialogue to ask optimum number of right questions from the user for quick identification of the most probable disease whereby mimicking the dialog between doctor and patient during the disease diagnosis process.

Hence the present invention provides a unique system and method for diagnosing most probable disease as it assists in separation between the user specific data on symptoms present and probabilities of diseases which is different for different users and the disease-symptom mapping which is same for every user. Algorithm is not relying on any complex decision tree logic to handle the dialogue to handle the dialogue where every user interaction requires this logic to be executed and state to be stored in the system memory. Instead it merely uses the symptom choices by the user and subsequent computation uses the same disease-symptom map. The structures related to disease-symptom mapping can be cached and used across different users. In one of the embodiments, for every dialogue, a function can accept the present symptoms array and the function can respond with top n symptoms for further calculation. Such an implementation ensures that there is no need for replicating the disease symptom matrix or a variant of that for every user and no need to store lot of data even between user interaction blocks within the dialogue. This reduces the memory requirement for the implementation to the very minimum and the entire system can be implemented in any device even with lower memory footprint, like a standard mobile phone.

### 4. BRIEF DESCRIPTION OF THE DRAWINGS

The foregoing and other features of embodiments will become more apparent from the following detailed description of embodiments when read in conjunction with the accompanying drawings. In the drawings, like reference numerals refer to like elements.

FIG. 1 illustrates a high level block diagram of the system for disease diagnosis through iterative discovery of symptoms according to one embodiment of the invention.

FIG. 2 illustrates the implementation of the Dialogue Manager according to one embodiment of the invention.

FIG. 3 illustrates general symptom disease mapping use by the Correlation Engine according to one embodiment of the invention.

FIG. 4 illustrates the forward mapping using correlation engine using Correlation Engine according to one embodiment of the invention.

FIG. 5 illustrates the forward mapping (symptom to disease mapping) and reverse mapping (disease to symptom mapping) by the Correlation engine according to one embodiment of the invention.

FIG. 6 illustrates the process flow of the Correlation Engine according to one embodiment of the invention.

FIG. 7 illustrates the optimization of the correlation algorithm using boost factor according to one embodiment of the invention.

FIG. 8 illustrates the categorization of the disease based on time from the onset of the disease with varying symptoms according to one embodiment of the invention.

### 5. DETAILED DESCRIPTION OF THE INVENTION

The detailed description presents an overview of the present invention followed by a brief description of each of the drawings. Specific examples are set forth in the detailed description part, in order to provide a thorough understanding of the present invention to any person skilled in the art. Embodiments of the invention are illustrated by means of example and figures only to illustrate the concept and not the actual architecture of the implementation.

One or more embodiments of the invention relate to a iterative software based disease diagnosis system that uses dialog based approach and matrix based correlation engine to diagnose disease accurately based on the initial set of symptoms entered by the user. Key focus of the present invention is the correlation engine that drives the dialogue to ask optimum number of right questions for quick identification of disease.

In one or more embodiments of the invention, symptom identification starts with a dialog between the user and system, based on which the system correlates and identifies probable disease (s) and the symptom (s) that has the maximum potential to narrow down the search, so as to reach faster conclusion on disease type. At the end of dialog between the user and system, system is able to compute the most probable disease (s) based on the weightages associated with various symptoms.

The term ‘symptom’ used herein represents the symptoms that an average user enters based on observations as well as the symptoms that need laboratory tests for confirmation before answering yes or no.

In one or more embodiments of the present invention, the system uses only the disease-symptom mapping as the source for the entire correlation. Mapping between the disease (s) and symptom (s) is not static as the new diseases and symptoms can be added, or existing mapping can be updated on an ongoing basis. At any time when this mapping data is updated or modified, system triggers the pre-computation module and updates the matrix for run time access. The system uses numeric value with the likelihood of the disease which is essentially useful if more than one disease occurs at the same time and user wants to know the relative comparison between these two disease probabilities.

In one or more embodiments of the present invention, the system is implemented as a web based application or a standalone application on any platform or a hybrid combination between these two approaches on any of the technology platforms like PC/laptop, tablet, mobile, Television, gaming console or any other technology platform that allow 2-way communication with the end user.

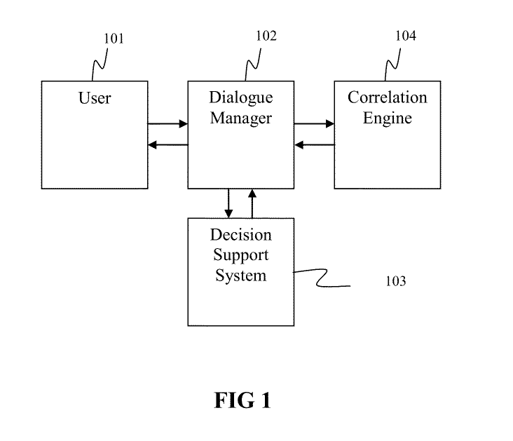

FIG. 1 illustrates a high level block diagram of the system for disease diagnosis through iterative discovery of symptoms according to one embodiment of the invention. Working of the overall system involves the interaction of the three key components, Dialog Manager (102), Correlation Engine (104) and Decision Support Engine (103) which is explained as below.

In most preferred embodiment, the system for disease diagnosis through iterative discovery of symptoms comprises a Dialog Manager (101) having a user interface to receive initial disease symptoms from the user. A User (101) can be a patient or a doctor or a hospital staff who decides the department or a doctor to whom the patient shall be referred to or any other user of the system. The Dialog Manager (102) handles the interaction between the user (101) and the system. The user interface of the Dialog Manager (102) allows the user (101) to input the initial confirmed symptoms and other user related inputs that can be used for optimization of disease identification such as age, gender, previous history of disease (s) etc. The information received by the Dialog Manager (102) is transmitted to the Correlation Engine (104) that further analyses and handles further dialog with the end user (101) by taking more inputs if needed.

The system essentially includes a Correlation Engine (104) to output the probability of the diseases based on the inputs from the Dialog Manager (101) by establishing correlation of symptoms with disease type to identify the probable disease. Based on the initial symptoms selected by the user (101), the Correlation Engine (104) uses the disease-symptom map for further dialogue wherein a list of probable symptoms for the probable disease is listed. The Dialog Manager (102) then presents the list of probable symptoms to the user (101) and gets the confirmation, which is passed back again to the Correlation Engine (104). The above process is repeated until Dialog Manager (102) detects that the probability of one or more diseases is greater than the threshold or completion of a fixed number of iterations as computed by the Correlation Engine (104). Based on the conclusions, Dialog Manager (102) requests the Decision Support Engine (103) for further suggestions and handles the subsequent interaction between the user (101) and Decision Support Engine (103). The system also includes a Decision Support Engine (103) to suggest further course of action in case the probability of any disease is greater than a predetermined threshold value.

The identification of the most probable disease is assisted through the dialogue between the user (101) and the system unlike the existing systems or software implementations that assume a user to know all symptoms in the beginning. This dialog based approach allows the questions (on whether a particular symptom is present or not) to be chosen based on their potential for faster identification that results in minimum number of questions to come to the conclusion. The system or the application correlates symptoms with disease (s) and identifies the probable disease (s).

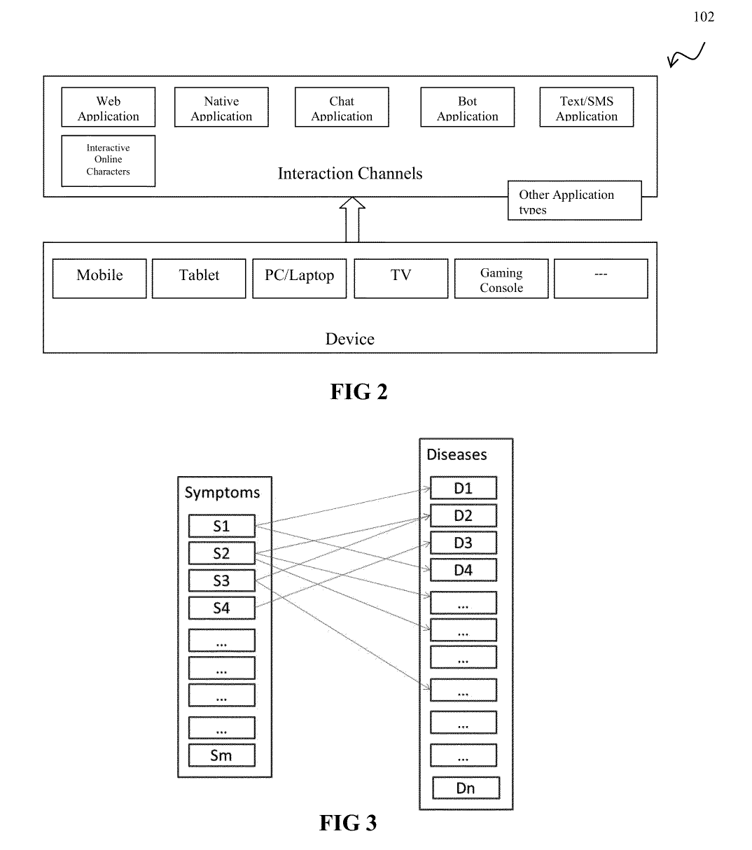

FIG. 2 illustrates the implementation of the dialogue manager according to one embodiment of the invention. The Dialog Manager (102) can be implemented using any technologies and devices that allow 2-way communication such as PC/laptop, tablet, mobile, Television, gaming console that can incorporate the Dialog Manager (102). At the application or interaction channel level, the Dialog Manager (102) may be any of the application paradigms like text based SMS application or a web application or a native application with rich user interface or a chat application or a virtual human character interacting with the end user using text chat or voice synthesis and voice recognition mimicking a doctor or any other type of application user interface paradigms that allow 2-way communication.

FIG. 3 illustrates general symptom disease mapping use by the correlation engine according to one embodiment of the invention. Every disease is associated with number of symptoms. Same symptom can be associated with number of diseases. The Correlation Engine (104) uses a correlation algorithm to identify disease (s) based on the symptoms selected by the user via Dialog Manager. Based on the set of initial symptoms, probabilities of diseases are computed.

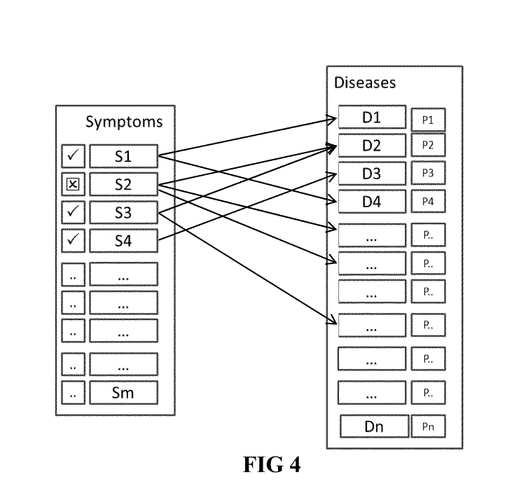

FIG. 4 illustrates the forward mapping using correlation engine using correlation engine according to one embodiment of the invention. Depending upon whether some symptoms are present or absent, the probability of diseases for the present symptoms can be computed. The correlation algorithm starts from confirmed initial symptoms to come up with some initial guess on the probable diseases as shown in the FIG. 4.

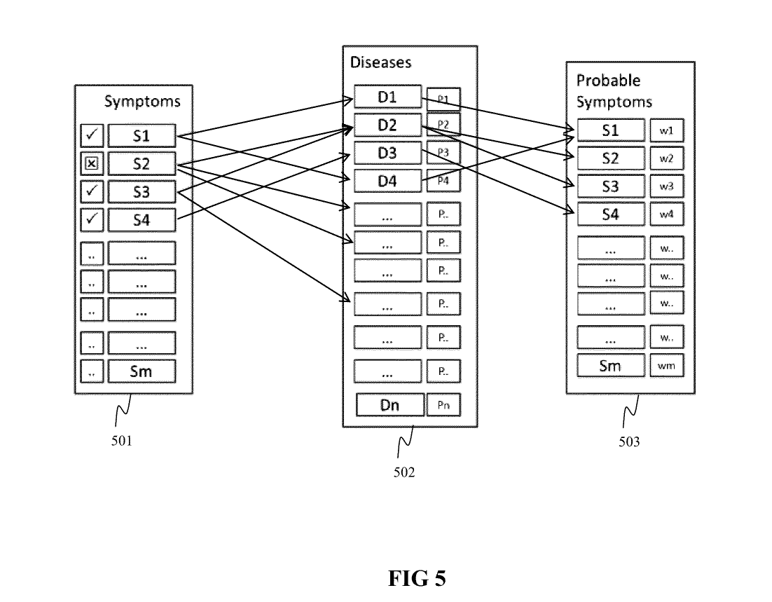

FIG. 5 illustrates the forward mapping (symptom to disease mapping) and reverse mapping (disease to symptom mapping) by the correlation engine according to one embodiment of the invention. As indicated in the figure, during forward mapping, The Correlation Engine (104) receives the confirmed initial symptoms (501) related to the disease from the Dialog Manager (102) and analyses the symptoms by establishing correlation of the symptoms with the probable disease (502) to identify the probable disease (s). Based on the relative probability of the disease, the Correlation Engine (104) computes the cumulative weightage or scores for associated symptoms for each disease. Cumulative value of these weightages for a specific symptom is considered as score for that symptom. Based on the scores, a ranked list of probable symptoms for each identified disease is prepared that has the maximum potential for a quick decision of disease. The symptoms are arranged in descending order of scores based on which the correlation engine (104) creates a subset of probable symptoms by selecting top few symptoms with highest scores for quick disease identification by the system. The topmost symptoms from the subset of probable symptoms will have the maximum impact in narrowing down the identification of disease. The subset of probable symptoms is shared with the Dialog Manager (102) for further confirmation from the user and this process is repeated based on a number of iterations or based on the probability of any disease that exceeds a preset threshold value. In one embodiment, while presenting list of probable symptoms as choices for selection, the initial symptoms are removed for confirmation of the specific disease whereby symptoms for which the user has already confirmed as either present or absent are not presented the next time. The Correlation Engine (104) completes the dialog and conveys the most probable disease and associated probabilities to the user (101) through Dialog Manager (102). The session information corresponding to the Dialog Manager (102) is maintained in order to optimize the queries and to ensure that no symptoms are verified the second time, once it has been confirmed positive or negative by the user (101). Since this dialog process and remembering of the previous symptoms (confirmed present or absent by the user) are handled by the Dialog Manager (102), the Correlation Engine (104) has no need for storing any user specific or dialog session specific information which reduces the memory requirement for the implementation to the very minimum and the entire system can be implemented even in any device with lower memory footprint like a mobile device. The system also has the ability to fine tune the Correlation Engine (104) based on the health profile and demographic information about the user (101).

The whole process may have a number of iterations wherein each iteration may narrow down on certain diseases based on the symptoms selected so far and asking the right questions for faster convergence exactly mimicking a doctor patient interaction.

This approach of identifying the most probable disease is similar to the iterative approach adopted by the human doctors. Based on set of symptoms, certain diseases are speculated and based on these speculations; more probable symptoms associated with these diseases are identified and verified with the user.

In case of a chat interface or voice based application, the top item from the list can be used for interaction with the user and getting the inputs for next iteration. E.g. the Dialog Manager may present the following question:

“Do you also have symptom x?”

In case of a rich user interface or web based applications, since those interactions channels can handle multiple confirmations at the same time, probably more than one symptom can be presented at one time to get user feedback for several symptoms in one interaction block.

E.g. a dialog box may present the following questions:

Do you also have the following symptoms?

Symptomx[yes/no]

Symptomy[yes/no]

In both these approaches top ‘n’ of the sorted list of probable symptoms to be verified is taken for further confirmation, ‘n’ being a number ideally suited for the user interface paradigm used. The whole process is repeated after receiving the confirmation from the user.

Algorithm represents the two way approach that is used by the doctor intuitively which is starting from a set of symptom to come to some initial guess on the probable diseases and then based on this set of diseases come up with the next set of symptoms to be verified and formulate corresponding questions to the patient or examinations. Each time the symptom that has the maximum impact in decision making is chosen for the dialog for faster disease identification. In both the forward and reverse paths, the symptom to disease mapping used, is exactly the same.

The system computes the weightages based on the symptoms to disease mapping stored. Based on the selection of the initial symptoms of the user, probabilities of diseases are computed based on the weightages. If the probabilities of diseases are greater than the threshold, program stops (from correlation perspective, for that user and for that session) and overall system control coordinated by the Dialog Manager starts to interact with the Decision Support Engine for further user interactions.

If the probability of any disease is less than the threshold, the cumulative weightage or scores are computed for each of the probable symptoms. Based on these scores, all the symptoms are ranked and the top ones are selected for confirmation. These symptoms are presented to the user for confirmation via Dialog Manager. Symptoms for which user has already confirmed either present or not are not presented second time. Based on the user response, the symptom choices are again passed for probability calculations. The iteration continues for fixed number of times or probability greater than threshold, whichever happens first to exit from the loop.

### Implementation of the Correlation Algorithm

In one embodiment of the invention, the correlation algorithm may be implemented using below mentioned methods:

Assuming a set of diseases as an array, Diseases Array=[D1, D2, D3, D4 . . . Dn]. Also assuming another set containing symptoms, Symptoms Array=[S1, S2, S3, S4 . . . Sm]. A mapping between the symptoms and corresponding diseases may be created using these two sets.

$$Symptom \text{-} Disease Mapping ( S D M ) = [ \begin{matrix}S 1 D 1 & S 1 D 2 & … & S 1 Dn \\ S 2 D 1 & … & … & … \\ … & … & … & … \\ Sm D 1 & … & … & SmDn\end{matrix} ]$$

In one embodiment of the invention, each element of the Symptom-Disease mapping matrix is either 0 or 1 depending upon whether the symptom is present or not for that disease.

$$Symptom \text{-} Disease mapping array sample = [ \begin{matrix}0 & 1 & 0 & 1 \\ 1 & 1 & 1 & 0 \\ 1 & 1 & 1 & 1 \\ 0 & 0 & 1 & 0\end{matrix} ]$$

In the above example, Disease D1 is related to symptoms S2 and S3, and disease D2 is related to symptoms S1, S2 and S3 and so on.

Another mapping between the disease and corresponding symptoms can also be created using these two sets.

$$Disease \text{-} Symptom Mapping ( DSM ) = [ \begin{matrix}D 1 S 1 & D 1 S 2 & … & D 1 Sm \\ D 2 S 1 & … & … & … \\ … & … & … & … \\ DnSm & & & DnSm\end{matrix} ]$$

DSM and SDM are transpose of each other with the rows and columns interchanged but containing exactly the same symptom to disease mapping.

SDM=DSM^{T}
DSM=SDM^{T}

From this mapping data of whether a symptom is related to a disease or not (1 or 0 values), weightages can be computed. Weightage for every Symptom-Disease element is computed using the following formula:

$$Symptom \text{-} Disease Weightage Wxy = SxDy / {\sum }_{y = 1}^{y = n} SxDy$$

$$Symptom \text{-} Disease weightage matrix based on SDM = [ \begin{matrix}w 11 & w 12 & … & w 1 n \\ w 21 & … & … & … \\ … & … & … & … \\ wm 1 & … & … & wmn\end{matrix} ]$$

In the above matrix, row wise addition represents the weightages of a specific symptom across all the diseases and column wise addition represents the sum of weightages of all the symptoms for a specific disease.

$${\sum }_{y = 1}^{y = n} wxy = 1 for any row \times ( or Symptom Sx )$$

Maximum score corresponding to any Disease Dy is defined as

$$MaxScore ( Dy ) = {\sum }_{x = 1}^{x = m} wxy$$

Based on these weightages, two matrices, SDW and DSW are created corresponding to SDM and DSM, by replacing the 1 and 0 by actual weightages.

$$Symptom \text{-} Disease Weightage ( SDW ) = [ \begin{matrix}w 11 & w 12 & … & w 1 n \\ w 21 & … & … & … \\ … & … & … & … \\ wm 1 & & & wmn\end{matrix} ]$$

$$Disease \text{-} Symptom Weightage ( DSW ) = [ \begin{matrix}w 11 & w 12 & … & w 1 m \\ w 21 & … & … & … \\ … & … & … & … \\ wn 1 & & & wnm\end{matrix} ]$$

Here also the weightages are same in both matrices and it is only their positions that are transposed, and has exactly the same relationship as between SDM and DSM:

SDW=DSW^{T}

DSW=SDW^{T}

MaxScore for any disease remains the same in row wise or column wise addition. MaxScore (Dy) is same for any disease Dy irrespective of SDW or DSW used for computation.

Present Symptoms (PS) array represents the symptoms that are present, based on user inputs so far in the iterative process.

$$Present Symptoms Array PS = [ \begin{matrix}Ps 1 \\ Ps 2 \\ Ps 3 \\ Ps 4 \\ … \\ … \\ … \\ … \\ Psm\end{matrix} ]$$

Each of the PSx represents 1 or 0 depending upon whether symptom Sx is present or not. Therefore, if symptoms S1 and S2 are present, then the sample array will be as given below.

$$Present Symptoms Array Sample = [ \begin{matrix}1 \\ 1 \\ 0 \\ 0 \\ 0 \\ 0 \\ 0 \\ 0\end{matrix} ]$$

Disease Probability (DP) matrix represents the probability of a disease based on the symptoms.

$$Disease Probability Array DP = [ \begin{matrix}DP 1 \\ DP 2 \\ … \\ … \\ DPn\end{matrix} ]$$

In one embodiment of the invention, another array is used to hold the symptoms scores based on their likelihood to narrow down further search for identifying the disease.

$$Possible Symptoms Score ( SC ) = [ \begin{matrix}SC 1 \\ SC 2 \\ SC 3 \\ SC 4 \\ … \\ … \\ … \\ … \\ SCm\end{matrix} ]$$

The forward path for calculating Disease Probability (DP) based on a given set of symptoms is given below.

DP=DSWXPS

Corresponding Matrix multiplication is shown below:

$$[ \begin{matrix}DP 1 \\ DP 2 \\ … \\ … \\ DPn\end{matrix} ] \begin{matrix}= \\ =\end{matrix} ( \begin{matrix}w 11 & w 21 & … & wm 1 \\ w 12 & … & … & … \\ … & … & … & … \\ w 1 n & … & … & wmn\end{matrix} ) \times [ \begin{matrix}Ps 1 \\ Ps 2 \\ Ps 3 \\ Ps 4 \\ … \\ … \\ … \\ Psm\end{matrix} ]$$

To make it normalized, the above scores are divided by the respective MaxScore for that disease.

DP′x=DP/MaxScore(Dx)

DP′ computed as per above formula, gives the probability of diseases Dx to be present, based on selected symptoms.

$$[ \begin{matrix}DP {1}^{′} \\ DP {2}^{′} \\ … \\ … \\ {DPn}^{′}\end{matrix} ] = [ \begin{matrix}DP 1 \div MaxScore ( D 1 ) \\ DP 2 \div MaxScore ( D 2 ) \\ … \\ … \\ DPn \div MaxScore ( Dn )\end{matrix} ]$$

The reverse path of computing to identify the possible symptoms based on probability of diseases is given below:

SC=SDWXDP′

Corresponding Matrix multiplication is shown below:

$$[ \begin{matrix}SC 1 \\ SC 2 \\ SC 3 \\ SC 4 \\ … \\ … \\ … \\ … \\ SCm\end{matrix} ] = ( \begin{matrix}w 11 & w 12 & … & w 1 n \\ w 21 & … & … & … \\ … & … & … & … \\ wm 1 & … & … & wmn\end{matrix} ) \times [ \begin{matrix}DP {1}^{′} \\ DP {2}^{′} \\ … \\ … \\ {DPn}^{′} \end{matrix} ]$$

Based on the above computations, a possible symptom score array is obtained that holds the relative scores for each of the symptoms. For example, symptom S1 has a score of SC1.

The symptom matrix

$$[ \begin{matrix}S 1 \\ S 2 \\ S 3 \\ S 4 \\ … \\ … \\ … \\ … \\ Sm\end{matrix} ]$$

is sorted using the score matrix values

$$[ \begin{matrix}SC 1 \\ SC 2 \\ SC 3 \\ SC 4 \\ … \\ … \\ … \\ … \\ SCm\end{matrix} ]$$

The top values of this sorted array represent the symptoms that have the most potential for a quick decision of the possible disease. If the symptom has already been verified (positive or negative) by the user, it is not considered for the query second time.

In accordance with one or more embodiments of the invention, if the disease identification process is complete, the entire information related to the symptoms selected so far and the most probable disease(s) are transferred to Decision Support Engine (103) for further course of action which includes suggesting a further diagnostic tests to confirm the identified disease, routing user to a specific department in a hospital, suggesting a specialist doctor within a hospital, suggesting a specialist doctor close to patient's geographical location, scheduling a lab test, ordering the required medicines online, blocking the calendar for consultation with the doctor etc. The Decision Support Engine (103) can even suggest immediate help if disease (s) detected is critical or life threatening. The Decision Support Engine (103) is not just one single system but it can be a collection of different Decision Support Engines each one serving a set of specialized decisions. Decision Support Engine (103) may have also have user interface embedded with real-time video chat with the actual doctor in case the identified disease is critical. This facility is especially useful in telemedicine where the initial disease is handled by self-service leveraging the machine based correlation engine, which is then routed to an appropriate specialist doctor for further discussion. One of the advantages of this approach is the optimization of time spent by specialist doctors since most of the preliminary disease detection process has already been done as a means of self-service by the user before the specialist doctor starts attending the patient for further discussions.

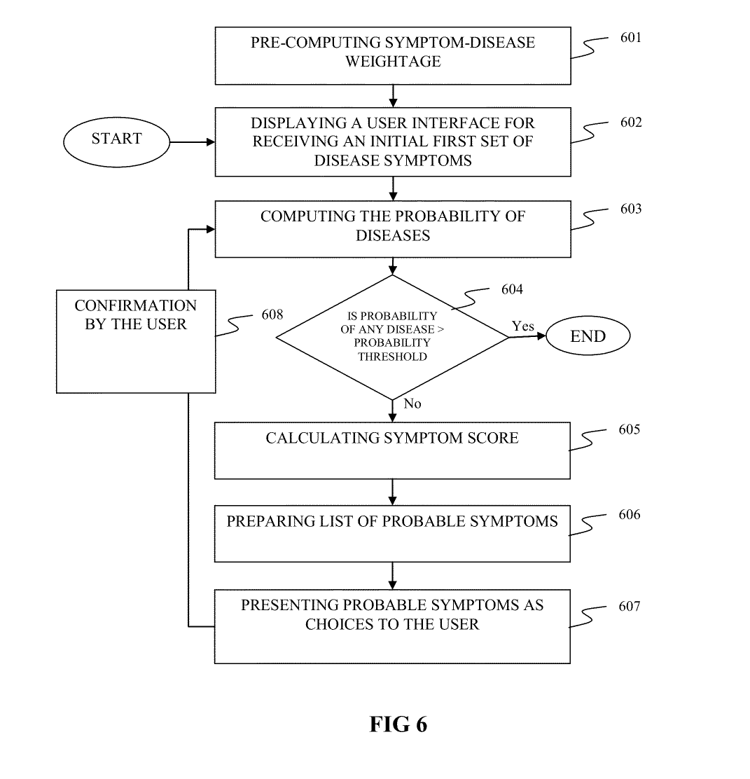

FIG. 6 illustrates the process flow of the correlation engine according to one embodiment of the invention. At step 601 before a session with the user begins, the correlation engine uses a correlation algorithm to pre-compute symptoms-disease weightage during the initial setup to reduce computation load and processing time during user interactions. Based on this data, SDW (and DSW) are pre-computed and kept in the engine before the user starts interacting which increases the overall performance of the system since it need not be computed again and again for every user. DSW and SDW need not be separate matrices but programmatically taken from the same matrix. In another embodiment of the invention, the step 601 can be avoided and the computation can be done during real time as well. But since the disease-symptom map used for every user is same; weightages can be computed upfront to reduce the computation load and processing time for every user during the dialogue process.

The method initiates at step 602 where the Dialog Manager displays a user interface to the user for receiving confirmed initial disease symptoms. The correlation algorithm uses the initial selection of symptoms by the user to compute the probability of diseases.

At step 603, the system calculates the probability of the disease (s). In this step, based on the initial user symptoms and subsequent confirmations, Present Symptoms (PS) array is populated with 1 s and 0 s for further computation of the probability of any disease which is used for the computation of the probability of every disease based on the symptoms selected. At step 604, a check is made whether the probability of any disease computed at step 603 is greater than the predetermined threshold value or not. If the result of the check made at step 603 is affirmative, which means that the probability of the disease is more than the threshold value and the system has successfully identified a disease based on the symptoms input by the user, the program ends and the overall system control coordinated by the Dialog Manager (102) is transferred to the Decision Support Engine (103) for further user interactions such as for further diagnostic tests or for recommendation of doctors or departments within the hospital or locating the doctors or hospitals within the patient's geographical location or any other preferences.

In case the result of the check made at step 604 is negative, which means that the probability of the all the possible diseases are less than the threshold value and the system is not able to detect or identify the disease based on the symptoms input by the user. In this case the cumulative weightage or scores for each probable symptom based on the probable diseases are calculated for narrowing down the search further. The weightage of a symptom is the elementary value (weight) associated with each symptom for a specific disease. The score is the sum or cumulative values of different weightages for the same symptom across different diseases with associated probabilities. Score is used to identify which is the topmost symptom that needs confirmation. A cumulative weightage allows to compare and contrast between different symptoms: for example a symptom that has the highest chance of convergence (like a red eye) vs. a symptom that has very less chance of confirming (like mild fever).

A ranked list of the probable symptoms for each of the probable disease (computed at step 603) is prepared at step 605. In this step each probable symptom is arranged in a ranked list in descending order of their scores for quick disease identification by the user. The weightages of probable symptoms are computed based on the probability of diseases and for their relative potential to narrow the search whereby symptoms corresponding to disease with higher probabilities as compared to other symptoms are boosted based on the above calculation. These symptoms have higher chance of converging on the disease identification. The probability of a disease is also optimized based on patient's gender, age, demography, health profile, health history of past diseases, stage of disease, primary/secondary diseases, hereditary issues and the total time lapsed from the onset of diseases to enhance the accuracy of the disease identification, as explained later.

At step 606, a list of probable symptoms is prepared from the ranked list wherein only the topmost probable symptoms are selected for further processing. At step 607, the list of probable symptoms is presented as choices for probability calculations to the user via Dialog Manager (102). While presenting the probable symptom as choices next time, the symptoms for which the user has already confirmed either present or not are not presented second time to the user. From the remaining list, Top n questions are selected and presented to the user for the next iteration dialogue, wherein ‘n’ is a number defined by the user interface paradigm used by the Correlation Engine (104). Based on the user response, the symptom choices are again passed for probability calculations to step 603 wherein all the steps from 603 to 608 are repeated in the same manner as explained above till a most probable disease is identified. The iteration continues for fixed number of times or till the probability of any of the diseases is greater than threshold value, whichever happens first to exit from the loop. In another embodiment, it is also possible for continuing the iterations even after one of the suspected diseases has probability greater than the threshold. This additional logic of continuing the dialog even after identifying one disease with probability greater than threshold is needed for several reasons like identifying whether multiple disease are present, forceful verification of all symptoms of a disease (like in case of epidemic) etc. It is also quite possible that even after iterating for a fixed number times, none of the diseases were identified that crosses the threshold value of the probability and user may want to continue the investigation further. So the logic of exiting from the iteration loop can be a combination of user decision and programmatic decisions. Session information corresponding to each user is maintained in the Dialog Manager (102) order to optimize the queries and to ensure that no symptoms are verified the second time, once symptoms have been confirmed positive or negative by the user.

### Implementation and Optimization of Correlation Engine

The present invention provides a unique system and method for diagnosing most probable disease as it assists in separation between the user specific data on symptoms present and probabilities of diseases which is different for different users and the disease-symptom mapping which is same for every user. Algorithm is not relying on any complex decision tree logic to handle the dialogue where every user interaction requires this logic to be executed and state to be stored in the system memory. Instead it merely uses the symptom choices by the user and subsequent computation uses the same disease-symptom map and correlation engine leveraging solely that information for decision making. The structures related to disease-symptom mapping can be cached and used across different users. In one of the embodiments, for every dialogue, a function can accept the present symptoms array and the function can respond with Top n symptoms for further calculation. Such an implementation ensures that there is no need for replicating the disease symptom matrix or a variant of that for every user and no need to store lot of data even between user interaction blocks within the dialogue. This reduces the memory requirement for the implementation to the very minimum and the entire system can be implemented in any device even with lower memory footprint, like a standard mobile phone.

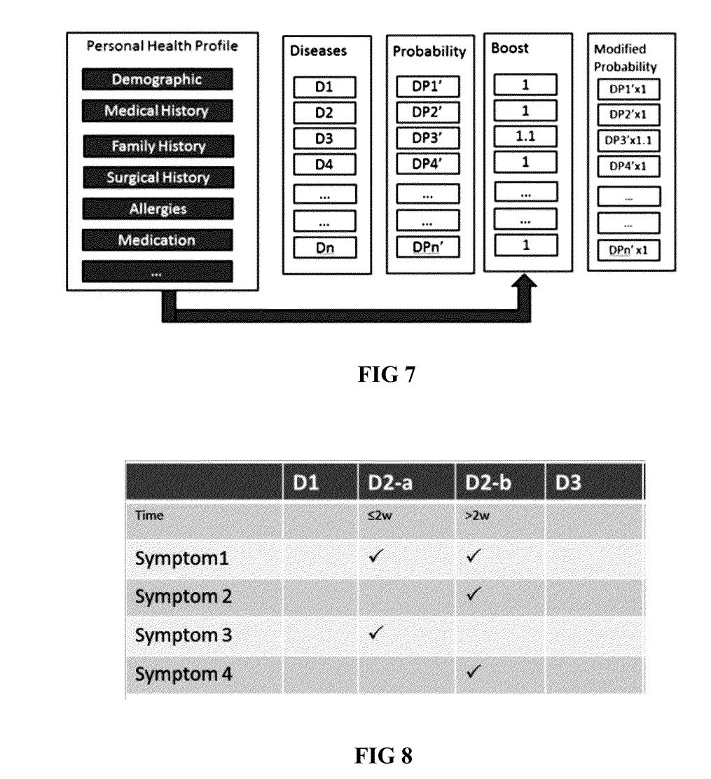

FIG. 7 illustrates the optimization of the correlation algorithm using boost factor according to one embodiment of the invention. There are several ways of optimization that can be applied to the proposed correlation algorithm. According to one embodiment of the invention, the optimization of the correlation algorithm is done by calculating the probability of occurrence of disease based on user's demography, health profile, history, primary/secondary diseases etc to enhance the accuracy of the disease identification. For example, if the user has long term smoking habit, probability weightage corresponding to lung cancer is increased. This bias for disease identification is very similar to the bias that doctors have based on patient's health history of past diseases, hereditary issues like cancer in parents, demographic specific diseases etc. The engine is optimized for taking care of this bias as shown in the figure.

DP′(x)(modified)=DP′(x)XBoost(Diseasex)

Boost represents the increase on the probability of the disease (DP) based on the profile information. Modified DP′ can be used for subsequent calculations like Symptoms Score (SC) in the algorithm to have more accurate output. In the example shown in the FIG. 7, based on the information from the personal health profile of the user, the probability of disease D3 is boosted by 10%. So in the computations, the probability of D3 (DP3′), which is dynamically computed during every stage of the dialogue process, is multiplied by 1.1 (1+10/100). This is the new value of DP3′ used for further computations.

On the contrary to the above, boost can also be calculated by decreasing the probability of the occurrence of some diseases. There are some diseases that doctor can rule out as the initial candidate for analysis. For example, in cases where the user belongs to a country where malaria has been eradicated, it is better to reduce the probability of that disease until all other analysis is completed. In such a case instead of increasing the boost factor to greater than 1, the value would be less than 1 to accommodate the reduction in probability.

In both the above scenarios, the interim probability computations are amplified or attenuated. The final probability that is displayed to the end user reflects the actual value than this modified value and this modified value is used only for artificially modifying the probability bias for or against certain diseases during the detection phase.

In another embodiment, the correlation algorithm can also be optimized by aligning the names of the symptoms of the matrix to the user preferences, especially in scenarios where the software system is used by non-doctors in self-user scenario. Synonyms of the disease can also be used in order to make sure that there is no discrepancy related to identification of the disease. For example, “Gingivitis” and “painful gums” may be referring to the same symptom but depending upon user characteristics, they may opt for one word against another. Even though the internal representation of the disease and symptoms can be represented in standard codes (like ICD-10, International Statistical Classification of Diseases and Related Health Problems), these multiple symptom names are used for user inputs and confirmation. From implementation perspective this can be handled through programmatically mapping these synonymous symptoms to the same internal symptom representations (thereby avoiding duplication) for inputs and using the preferred name set based on customization data corresponding to that user, for asking for confirmations.

In yet another embodiment, the optimization of the correlation engine may also be done based on other factors such as gender, age or other characteristics of the user. As a result some of the diseases and symptoms are eliminated from the overall map, thereby reducing the map size. For example, diseases like “Breast cancer” and symptoms like “irregular periods” are only applicable to female (gender specific) in a given age group.

In one more embodiment, the optimization of the correlation engine can also be done based upon the stage of the disease. Several of the diseases have varying symptoms depending upon the stage of the disease. For example, initial symptoms of Lyme disease are skin rashes in a specific “bulls eye” pattern, joint stiffness etc., but if left untreated, within a couple of weeks, the disease may spread to heart and nervous systems of the patient. This can result in totally different set of additional symptoms such as abnormal heart rhythm, facial muscle paralysis etc.

FIG. 8 illustrates the categorization of the disease based on time from the onset of the disease with varying symptoms according to one embodiment of the invention. In this embodiment, the disease may also be categorized based on time from the onset of the disease with varying symptoms as shown in the figure and whenever the symptoms are correlating to the particular disease, additional question are triggered on how long this symptom has been going on and suitably switch the disease.

As depicted in the symptom disease map shown in FIG. 8, both D2-a and D2-b represent the same disease, whereas one disease is less than 2 weeks since the onset and another one is greater than 2 weeks. Whenever the user selects symptom 1, either as the first significant symptom at the start of the dialogue process or at the middle of the dialogue when the system asks the user for Symptom 1 and user confirms yes, then an additional question is posed to choose between “less than 2 weeks” or “greater than 2 weeks” since the onset of the symptom. If the user has answered greater than 2 weeks, then D2-a can be removed for further processing.

In one more embodiment, instead of binary 1 or 0 relationship between disease and symptoms, confidence factors can be used (say x % chance of a symptom being present or a fraction between 0 and 1 representing this fuzziness). The entire computation and logic will be exactly the same as described above.

In another possible optimization, the correlation algorithm may be optimized based on the conditions prevailing at a particular geographical location of the user. For example, if the user belongs to an area having an epidemic outbreak, the disease can be forced to be included for validation even though it is not related to the initial symptom (s) selected by the user since the probability of occurrence of epidemic disease is high.

In another embodiment, the state of the dialogue is saved for continuing in future, after some specific diagnostic tests are to be conducted before continuing the dialogue. For example, system can ask for a specific medical test to be conducted (e.g. test whether Blood Pressure or Cholesterol level is normal or not) before continuing the dialogue. In such cases, the state is saved and user can come back at a later time and resume the session.

### Modification of the Symptom—Disease Map:

Mapping between diseases and symptoms are not static. Newer diseases and symptoms will be added on an ongoing basis. Any time this mapping data is updated or modified, system can trigger the pre-computation module (Step 601 in the flow chart with respect to FIG. 6) and update the matrix for run time access.

### Deployment of the System

According to one embodiment of the invention, the three components of the system namely, Dialogue Manager (102), Correlation Engine (104) and Decision Support Engine (103) are loosely coupled and many different deployment configurations can be created based on this loose coupling. One of the advantages of defining the system based on these 3 loosely coupled components is that it can be distributed in different deployment environments as per specific requirements. The Decision Support Engine (103) need not be present in the same physical implementation environment of the Dialogue Manager (102) or the Correlation Engine (104). For example, a hospital can use a customized Dialogue Manager (102) wherein probably it is integrated with their hospital management system or their online portal, and a customized Decision Support Engine (103) for decisions specific to their hospital on patient routing to doctors and labs, but leveraging an external provider for the Correlation Engine (104).

According to one embodiment of the invention, the dialogue manager can be implemented in a client environment such as a mobile application, which can interact with correlation engine from one provider and one or more decision support engines from different providers for scheduling the lab test, getting into a video chat with the specialist doctor etc. Many such different deployment configurations can be created based on this loose coupling.

It is to be understood, however, that even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

I claim:

1. A system for disease diagnosis through iterative discovery of symptoms, said system comprising:
a) a Dialog Manager configured to receive confirmed initial symptoms from the user, said Dialog Manager allows subsequent interactions through a dialog for disease identification;
b) a Correlation Engine configured to analyse the input received from the Dialog Manager and to calculate the probability of diseases by mapping each symptom with probable disease stored in the database and in case the probability of any disease is less than a predetermined threshold value, presenting to the user a list of probable symptom related to probable disease to identify the most probable disease, said correlation engine being connected to a database having information of various diseases and related symptoms;
c) a Decision Support Engine to suggest further course of action upon detecting the most probable disease,
wherein the system automatically drives the dialogue to ask optimum number of right questions from the user for quick identification of the most probable disease whereby mimicking the dialog between doctor and patient during the disease diagnosis process.

2. The system as claimed in claim 1 wherein the probable symptoms further comprise subset from the topmost symptoms in a ranked list of symptoms of probable diseases wherein the subset from the topmost symptoms is presented to the user via Dialog Manager for further confirmation.

3. The system as claimed in claim 2 wherein the ranked list further comprises disease symptoms arranged in descending order of scores of all the symptoms of probable diseases.

4. The system as claimed in claim 3, wherein while calculating the scores of each symptom, the symptoms corresponding to disease with higher probabilities as compared to other symptoms are assigned more weightage to identify the topmost symptom that needs confirmation whereby presenting disease symptoms based on most likelihood of the disease.

5. The system as claimed in claim 1 wherein while presenting the probable symptoms to the user via Dialog Manager, the symptoms for which the user has already confirmed as either present or absent are not presented second time.

6. The system as claimed in claim 1, wherein the probable symptom choices are presented to the user via Dialog Manager for further confirmation from the user either for a fixed number of times or until the probability of any of the diseases is greater than a predetermined threshold value or combination of user decision and programmatic decisions.

7. The system as claimed in claim 1 wherein the correlation engine is implemented solely based on the symptom disease mapping.
a. The engine can also be optimized by using boost factor based on user's gender, age, demography, health profile, health history of past diseases, habits, stage of disease, primary/secondary diseases, hereditary issues and the total time lapsed from the onset of diseases to enhance the accuracy of the disease identification whereby replicating the disease identification bias similar to the bias considered by the doctors based on patient's health history of past diseases.

8. The system as claimed in claim 7.a wherein the value of boost factor is increased in case the probability of the occurrence of diseases is more.

9. The system as claimed in claim 7.a wherein the value of boost factor is decreased in case the probability of the occurrence of diseases is less.

10. The system as claimed in claim 1 wherein the correlation engine is optimized by mapping the names of the symptoms to an internal symptom representation for inputs and using the preferred name set based on customization data corresponding to that user, for asking for confirmations whereby making the system easily usable by non-doctors.

11. The system as claimed in claim 1 wherein the diseases are categorized based on the time from the onset of the disease with varying symptoms for correlating symptoms to a particular disease.

12. The system as claimed in claim 1, wherein a session information corresponding to the Dialog Manager and the Correlation Engine is maintained by the system in order to optimize the queries and to ensure that no symptoms are verified the second time, once symptoms have been confirmed positive or negative by the user and also to handle all the correlation optimizations.

13. The system as claimed in claim 1 wherein the course of action suggested by the decision support engine further comprise logical next steps for confirmation and cure of the identified disease wherein said steps comprises any of the following:
a. suggesting a further diagnostic tests to confirm the identified disease;
b. routing user to a specific hospital
c. routing user to a specific department in a hospital;
d. suggesting a specialist doctor within a hospital;
e. suggesting a specialist doctor close to patient's geographical location;
f. scheduling a lab test;
g. suggesting and ordering the required medicines online;
h. blocking the calendar for consultation with the doctor;
i. suggesting immediate help if the disease detected is critical or life threatening;
j. direct interaction with the doctor using any communication mode like text or video chat, whereby optimizing the time spent by doctors by performing most of the disease detection process by the user upfront through self-service or through assistance by non-doctors before the specialist doctor starts attending the patient for further discussions.

14. The system as claimed in claim 1, wherein all, the dialogue manager, correlation engine and decision support engine, can be distributed individually or in combination in different deployment environments as per specific requirements.

15. The system as claimed in claim 1, wherein said system is implemented on a 2-way communication technology that allows 2-way communication with the end user.

16. The system as claimed in claim 15 wherein said system is implemented as a web based application.

17. The system as claimed in claim 15 wherein said system is implemented as a thick client standalone application.

18. The system as claimed in claim 15 wherein said system is implemented as a hybrid combination between web based application and thick client standalone application in any of the technology platforms like PC/Laptop, Tablet, Mobile, TV, Gaming Console or any other technology platform that allows 2-way communication with the end user.

19. The system as claimed in claim 1 wherein the database (map between symptom and disease) accessed by the correlation engine is updated with newer diseases and new symptoms on an ongoing basis.

20. The system as claimed in claim 1 wherein the system can detect more than one disease from all the symptoms present, with associated relative probabilities, to help in relative comparison between diseases.

21. The system as claimed in claim 1 wherein the system supports multiple modes of user interaction for disease detection from the symptoms, said modes comprise at least one of:
a. Text/SMS mode;
b. voice based;
c. chat based; or
d. web based.

22. A method for disease diagnosis through iterative discovery of symptoms, said method comprising the steps of:
a) pre-computing the symptom-disease weightage to reduce computation load and processing time during the initial setup;
b) displaying a user interface for receiving confirmed initial disease symptoms from the user;
c) computing the probability of diseases by establishing correlation of symptoms with disease type to identify the probable disease,
a. in case the probability of any disease is greater than a predetermined threshold value, suggesting further course of action based upon the identification of the probable disease whereby successfully identifying the disease based on the symptoms selected by the user;
b. in case the probability of any disease is less than a predetermined threshold value,
i. calculating symptom scores for each probable symptom based on the probable disease;
ii. preparing list of probable symptoms by selecting subset from the topmost symptoms in the ranked list of symptoms for each of the probable diseases, wherein the ranked list further comprises probable symptoms for probable disease arranged in descending order of their score whereby symptoms having more significance for a disease are scored higher as compared to other symptoms to find out most probable disease;
iii. presenting list of probable symptoms as choices for probability calculations to the user;
d) suggesting further course of action to the user upon identification of the most probable disease,
wherein driving the dialogue to ask optimum number of right questions from the user for quick identification of the most probable disease whereby mimicking the dialog between doctor and patient during the disease diagnosis process.

23. The method as claimed in claim 22, wherein there is also an option of pre-computation of disease symptoms is avoided but the weightages are computed in real time.

24. The method as claimed in claim 22, wherein while presenting probable symptom to the user, the confirmed initial symptoms are removed for confirmation of the specific disease whereby symptoms for which the user has already confirmed as either present or absent are not presented second time.

25. The method as claimed in claim 22, wherein while calculating the score of each symptom, the symptoms corresponding to disease with higher probabilities as compared to other symptoms are assigned more score.

26. The method as claimed in claim 22, wherein the probable symptom choices are presented to the user for further confirmation either for a fixed number of times or until the probability of diseases is greater than a predetermined threshold value.

27. The method as claimed in claim 22 wherein the probability of a diseases is computed using boost factor based on user's gender, age, demography, health profile, health history of past diseases, habits, stage of disease, primary/secondary diseases, hereditary issues and the total time lapsed from the onset of diseases to enhance the accuracy of the disease identification whereby replicating the disease identification bias similar to the bias considered by the doctors based on patient's health history of past diseases.

28. The method as claimed in claim 27 wherein the value of boost factor is increased in case the probability of the occurrence of diseases is more.

29. The method as claimed in claim 27 wherein the value of boost factor is decreased in case the probability of the occurrence of diseases is less.

30. The method as claimed in claim 22 wherein the correlation engine is optimized by mapping the names of the symptoms to an internal symptom representation for inputs and using the preferred name set based on customization data corresponding to that user, for asking for confirmations whereby making the system easily usable by non-doctors.

31. The method as claimed in claim 22 wherein the diseases are categorized based on the time from the onset of the disease with varying symptoms for correlating symptoms to a particular disease.

32. The method as claimed in claim 22, wherein a session information corresponding to each user is maintained in order to optimize the queries and to ensure that no symptoms are verified the second time, once symptoms have been confirmed positive or negative by the user.

33. The method as claimed in claim 22 wherein the course of action after identification of the probable disease further comprise logical next steps for confirmation and cure of the identified disease, said steps comprise at least one of:
a. suggesting a further diagnostic tests to confirm the identified disease;
b. routing user to a specific hospital;
c. routing user to a specific department in a hospital;
d. suggesting a specialist doctor within a hospital;
e. suggesting a specialist doctor close to patient's geographical location;
f. scheduling a lab test;
g. suggesting and ordering the required medicines online;
h. blocking the calendar for consultation with the doctor;
i. suggesting immediate help if the disease detected is critical or life threatening;
j. direct interaction with the doctor using any communication mode like text or video chat, whereby optimizing the time spent by doctors by performing most of the disease detection process by the user before the specialist doctor starts attending the patient for further discussions.

34. The method as claimed in claim 22 wherein there is clear separation between the user specific data on symptoms present and probabilities of diseases and boost of probabilities based on biases etc. which are different for different users and the disease-symptom mapping which is same for every user that allows optimization of system resource usage in technical implementation.

35. The method as claimed in claim 22 wherein in case the probability of any disease is greater than a predetermined threshold value, the iterations are still continued for identification of multiple disease and forceful verification of all symptoms of a disease.
